(19) United States
(12) Patent Application Publication
(10) Pub. No.: US 2023/0398849 A1
(43) Pub. Date: Dec. 14, 2023

(54) Hardtop Hinge Device and System

(71) Applicant: Brian Goldwitz, Waterbury, CT (US)

(72) Inventor: Brian Goldwitz, Waterbury, CT (US)

(21) Appl. No.: 18/132,961

(22) Filed: Apr. 10, 2023

Related U.S. Application Data
(60) Provisional application No. 63/329,476, filed on Apr. 10, 2022.

(51) Int. Cl. B60J 7/16; E05D 3/02; E05D 7/00

(52) U.S. Cl. CPC B60J 7/1642; B60J 7/1657; E05Y 2900/542; E05D 7/009; E05D 3/02

(57) ABSTRACT

The current invention is a set of improved hinges and setup to attach a panel to the hardtop roof of a vehicle. A device that can lock the removable roof or hardtop in an open position. In the preferred embodiment the hinges are comprised of two or more separate hinges with each hinge connected to each panel by one or more flaps. The flaps may be aligned using an alignment bracket. After opening the panels, the panels are folded back on the hinges and can be locked to the roof of the vehicles with one or more locks located on the sides of the roof. The current invention is more flexible and has a better alignment system the back panel being larger than the front panel. The current system has a double hinged system which is an improvement.

### RELATED APPLICATIONS

This application is the non-provisional application of provisional application 63/329,476 dated Apr. 10, 2022, and claims that priority date.

### TECHNICAL FIELD

The technology discussed below relates hardtop hinges and more particularly hinges assemblies that connect panels to the hardtop in SUV vehicles.

### BACKGROUND

The changes in technology and needed functionality with vehicles. This is especially true with vehicle like jeeps and SUVs with hard tops with openable panels. The current methods can be hard to use and are not as structurally sound as the current invention. The current hinges don't function efficiently.

U.S. Pat. No. 11,192,432 is for a hinge system for a vehicle hardtop having a system with hinges (1) that allow a user to open and close a set of removable rigid rooftop panels (5, 6) for a Jeep or other sport utility vehicle without being required to fully remove and store the rigid roof panels. The hinges may be capable of supporting a partially opened position to prevent the panels from falling and slamming shut while opening. The current invention is more flexible and has a better alignment system the back panel being larger than the front panel. The current system has a double hinged system which is an improvement.

### SUMMARY

The current invention is a set of improved hinges and setup to attach a panel to the hardtop roof of a vehicle. A device that can lock the removable roof or hardtop in an open position. In the preferred embodiment the hinges are comprised of two or more separate hinges with each hinge connected to each panel by one or more alignment brackets. After opening the panels, the panels are folded back on the hinges and can be locked to the roof of the vehicles with one or more locks located on the sides of the roof. The current invention is more flexible and has a better alignment system the back panel being larger than the front panel. The current system has a double hinged system which is an improvement.

These are improvements over the current art.

### DRAWINGS

FIG. 1 is a top view of the device on a vehicle.

FIG. 2 shows the device on the top of a vehicle.

FIG. 3 shows a side view of the hinges.

FIG. 4 shows a closer view of the hinges.

FIG. 5 shows the hinges being used to fold the panel up.

FIG. 6 shows a bottom side view of the hinges being turned.

FIG. 7 shows the panel being moved on the hinges.

FIG. 8 a top view of the closed hinges.

FIG. 9 shows a single hinge for two sets of panels.

FIG. 10 shows the double hinge configuration with attachment screws.

FIG. 11 shows the alignment bracket.

FIG. 12 shows the alignment bracket in use with a set of panels.

FIG. 13 shows the alignment bracket with puzzle tabs.

FIG. 14 shows a hinge for each set of panels.

FIG. 15 shows a front alignment bracket with puzzle tabs.

FIG. 16 shows a front view of the latching mechanism.

FIG. 17 is another view of the latch.

FIG. 18 shows another style of the latch.

FIG. 19 shows the latch being closed.

### DETAILED DESCRIPTION

The illustrations presented herein are, in some instances, not actual views of any devices or components thereof but may be idealized representations which are employed to describe the present disclosure. Additionally, elements common between figures may retain the same numerical designation.

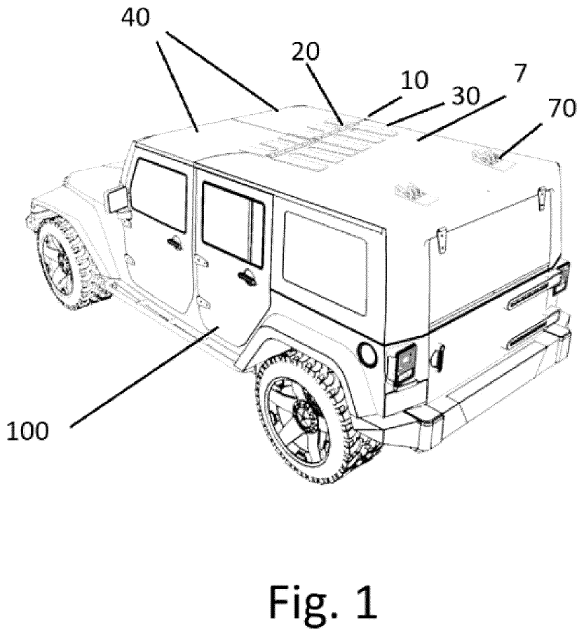

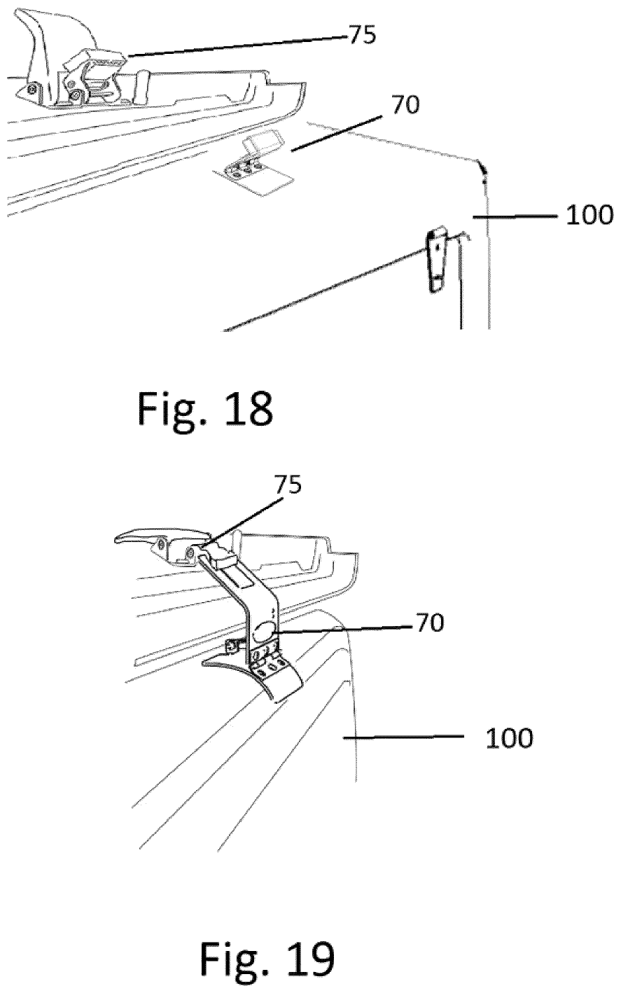

The current invention is a Hardtop Hinge Device and System as shown in FIGS. 1 through 19.

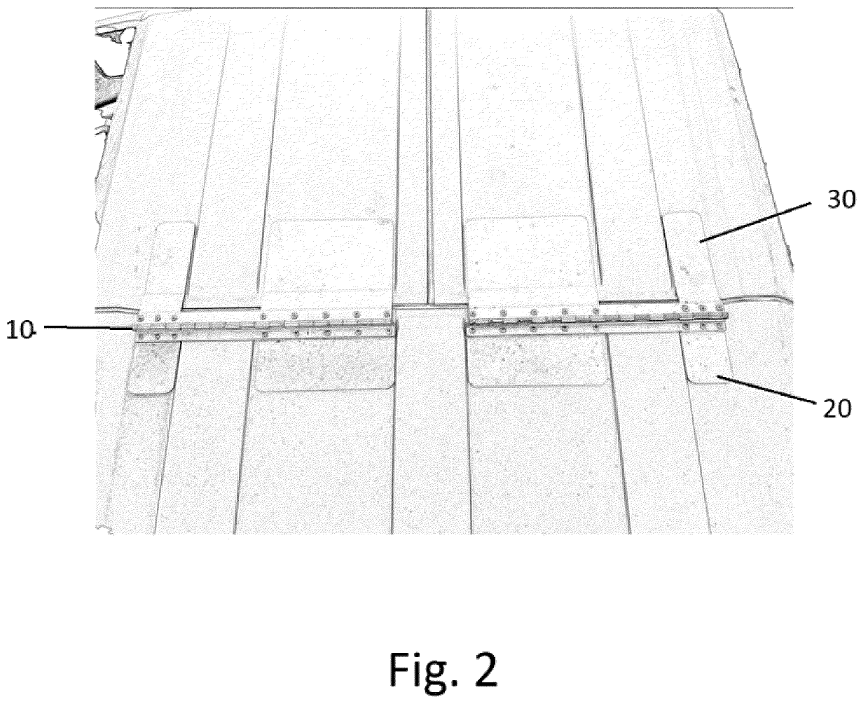

The device is a hardtop hinge device and system. FIG. 1 shows the device and system on the top of a vehicle on a SUV like a Ford Bronco O. As shown in FIG. 2, the device consists of front panels 20 and rear panels 30 which are connected by one or more hinges 10.

The rear panels 30 are larger than the front panels 20. This design allows a better and easier way to align the panels (20, 30) onto the rooftop panel 40. The rear panel 30 is aligned with the edge 5 of the roof where it meets the rooftop panel 40 and the corner edges of the raised parts 6 of the roof 7. This will allow for a proper alignment of the hinges and the panels (20, 30) on the roof 7 and the rooftop panels 40. The rear panels will follow the raised part 6 of the roof 7 for the best alignment. This will make the alignment of the front panels 20 on the rooftop panels 40 to be properly aligned.

A set of panels is made by one or more hinges 10 attaching one or more front panels 20 to the corresponding rear panels 30. The panels can be attached to the rooftop panel 40 and the roof 7 by screwing, welding, or gluing or any other attachment means. In the preferred embodiment, the hinge 10 footpad will be slightly offset from the edge 5 to allow better moving of the rooftop panels 40 from their closed to open position.

As shown in the Figures the panels (20, 30) are shaped so that they are positioned around the raised parts of the roof 7.

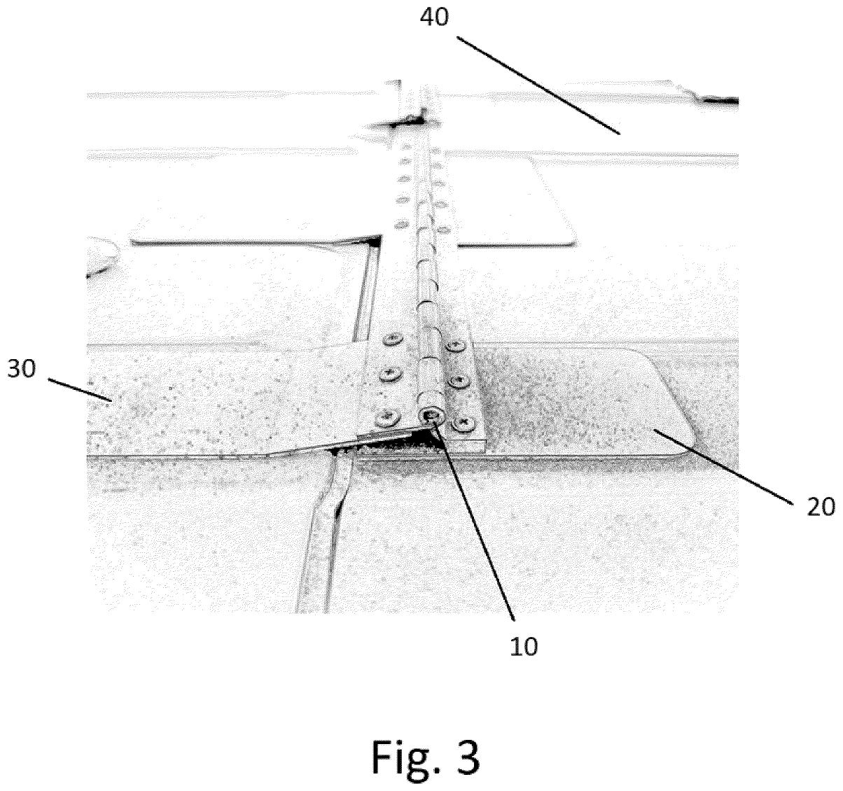

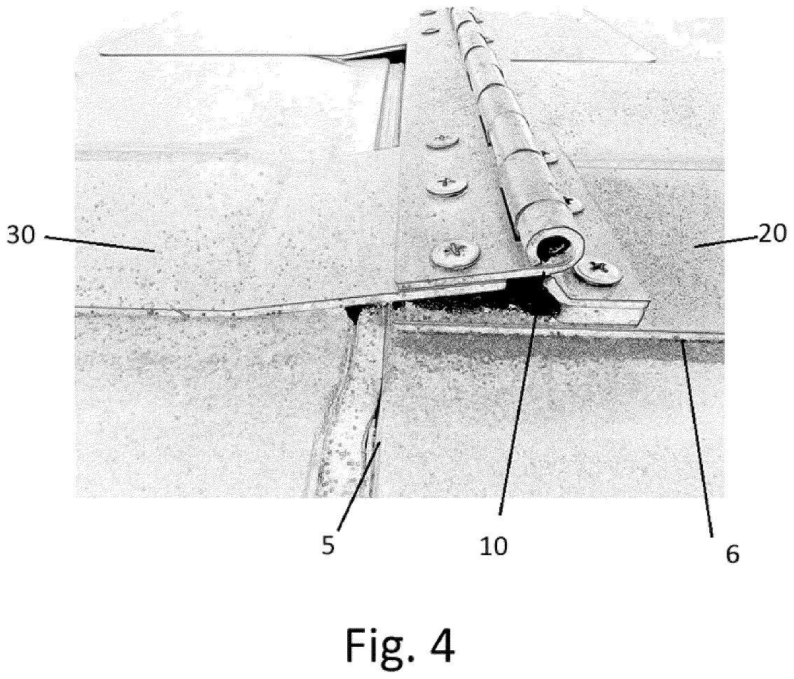

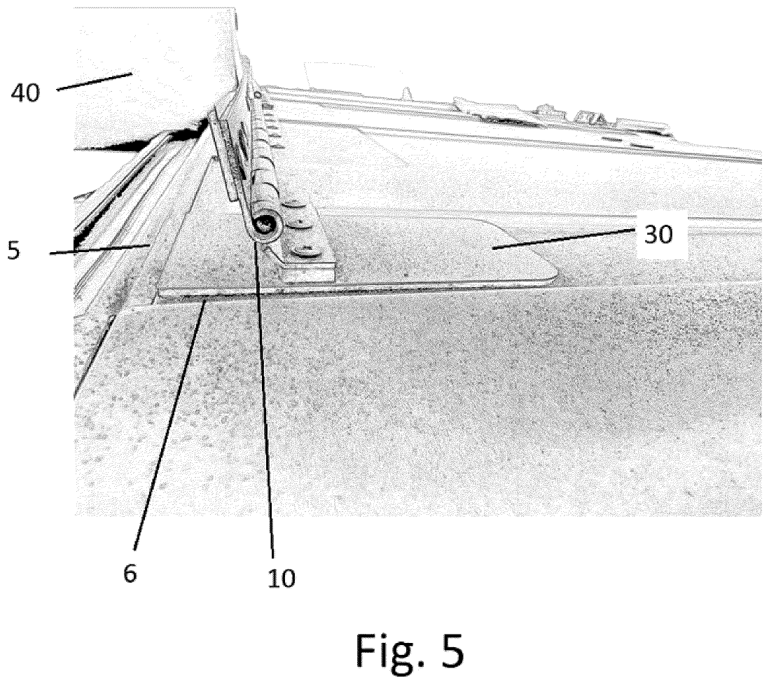

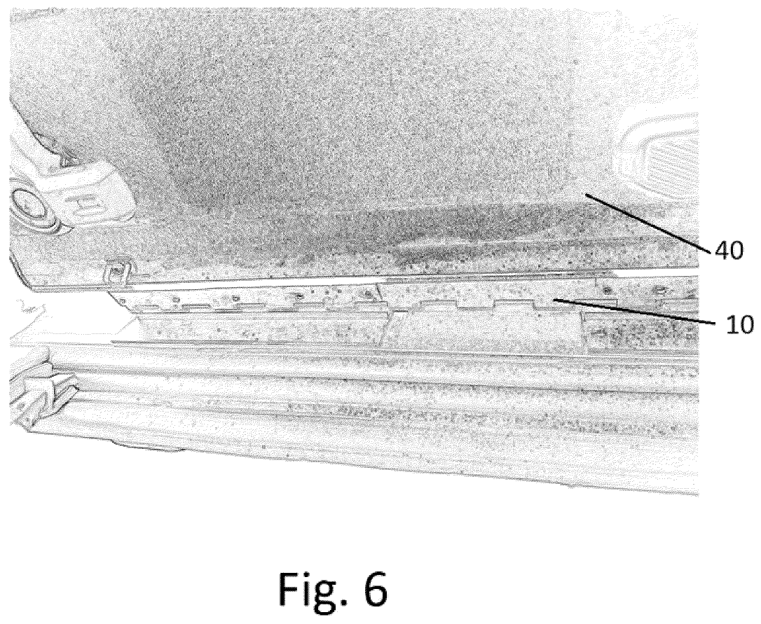

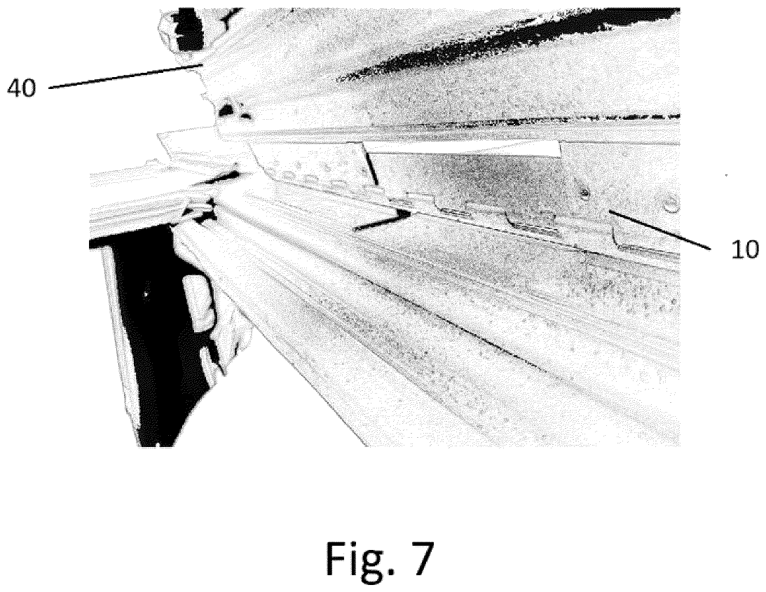

As shown in FIGS. 3 and 4 the hinge plate of the hinge 10 have a slight bend up angle to allow better turning of the hinge 10 when the rooftop panel 40 is moved open and back towards the locking latches 90 as shown in FIG. 5. FIG. 6 shows a view of the rooftop panel 40 being opened from inside the vehicle 100 while FIG. 7 shows a side view. The hinges 10 may be capable of supporting a partially opened position to prevent the rooftop panels 40 from falling and slamming shut while opening.

In an alternate embodiment, the front panel 20 can be larger than the back panel 30 if there is a need for better alignment or better to secure the rooftop panels 40 if this configuration is used.

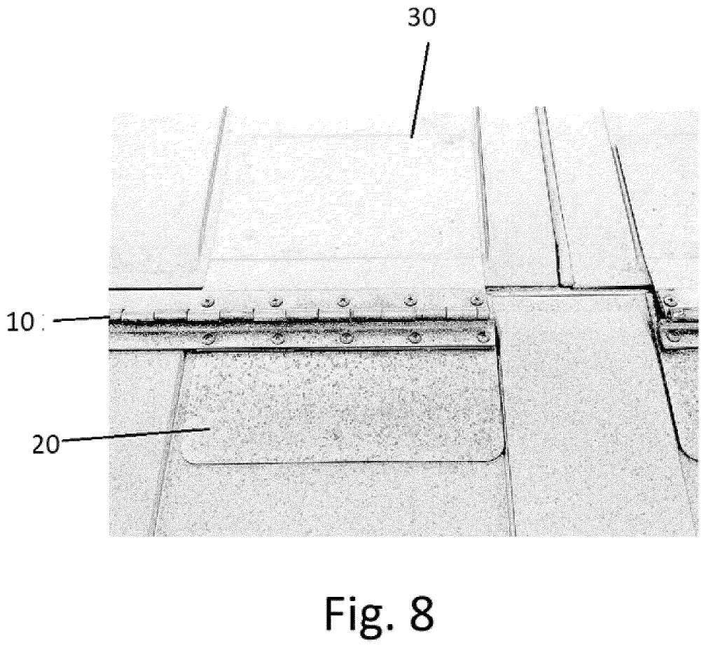

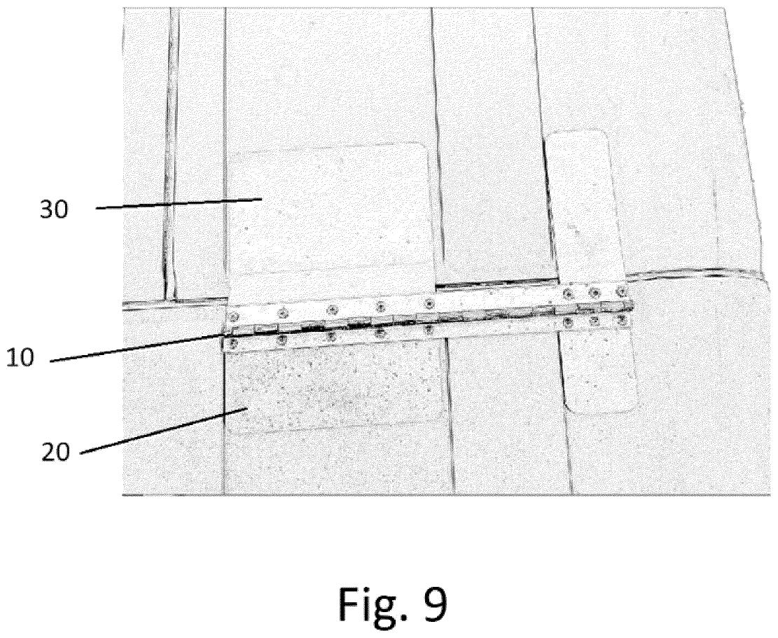

One hinge 10 across multiple front 20 and rear 30 panels being used to secure the rooftop panel 40 as shown in FIG. 9 or multiple hinges can be use separately as shown in FIG. 8

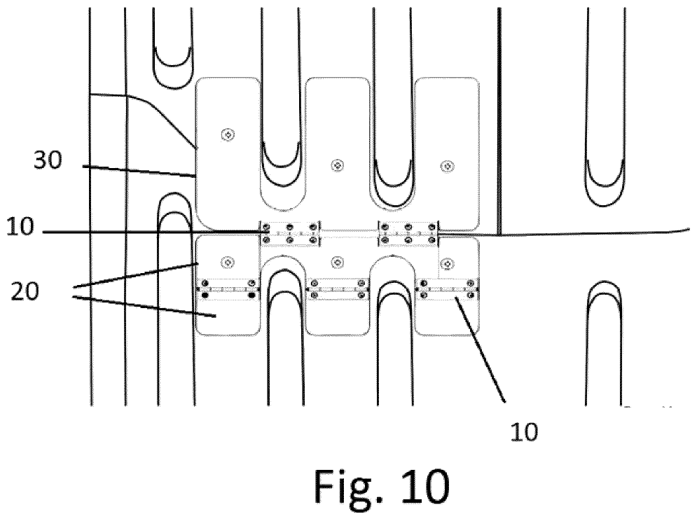

The current invention can also use a double hinge 10 configuration with attachment screws as shown in FIG. 10. This would allow the rooftop panel 40 to sit above a rooftop attachment such as a luggage rack.

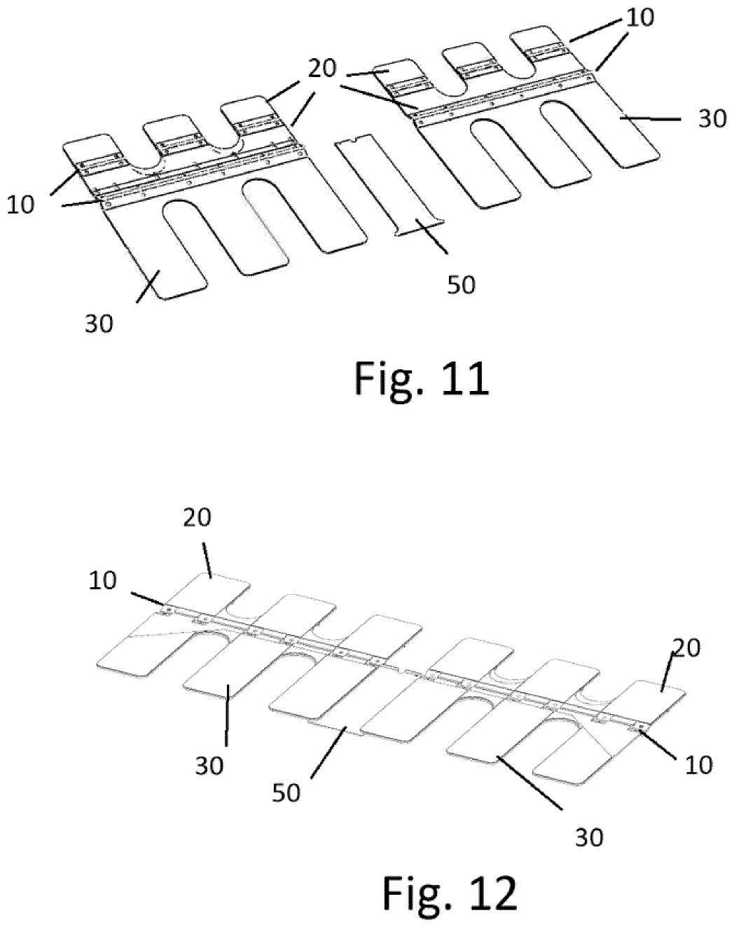

When the system is connected to a roof 7 of a vehicle an alignment bracket 50 can be used. The alignment bracket 50 has the proper width and shape that when it is placed between two sets of panels the sets will be at their proper alignment as shown in FIGS. 11 and 12.

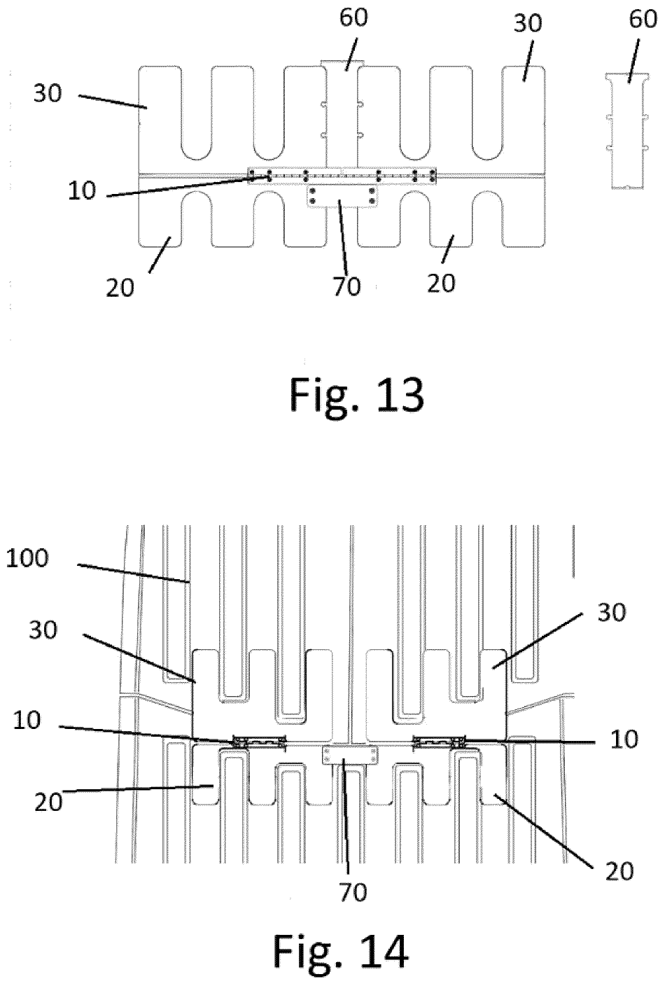

A tabbed alignment bracket 65 with puzzle like tabs can be used to temporarily connect the set of panels together allowing them to be properly positioned as if they were one piece as shown in FIG. 13. This can be very helpful when aligning and installing more than one panel set. A flat plate 70 can be used to permanently attach to sets of panels together as shown in FIG. 14 attached to either the front panel 20 or rear panel 30 using an attachment means like screws.

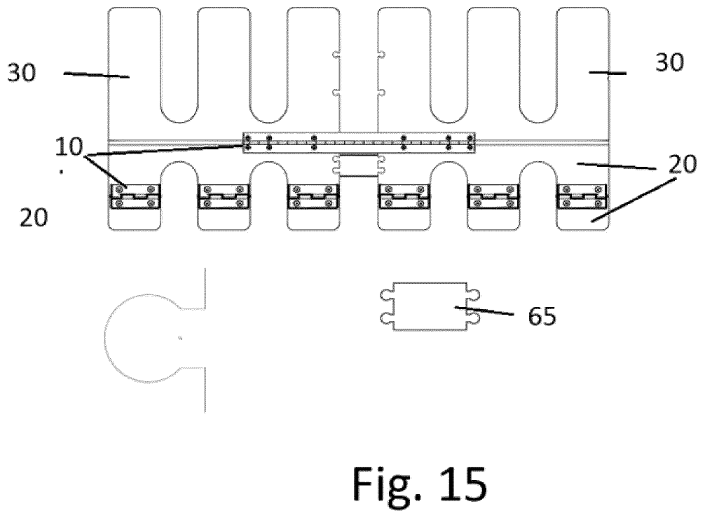

A smaller tabbed alignment bracket 65 can be used as shown in FIG. 15. This tabbed small alignment bracket 65 is especially good when alignment panel sets with multiple levels of hinges 10. FIG. 15 also shows the female piece to the male puzzle like tabs.

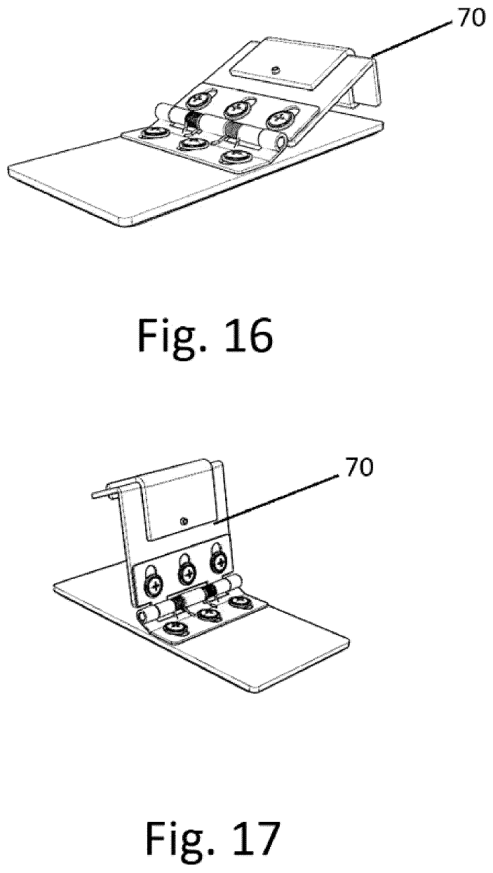

In the preferred embodiment, the system and device will have latching mechanisms and locking mechanisms 75 as shown in FIGS. 16, 17 and 18. FIG. 19 shows the rooftop panel 40 locked into place.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art.

What is claimed is:

1. A device comprising:
a hardtop hinge system having a front panel and a rear panel connected by a plurality of hinges.

2. A device according to claim 1 further comprising:
where rear panel is larger than the front panel.

3. A device according to claim 1 further comprising:
having an alignment bracket.

4. A device according to claim 1 further comprising:
where having the rear panel attached to the roof using an attachment means.

5. A device according to claim 1 further comprising:
where having the front panel attached to the rooftop panel using an attachment means.

6. A device according to claim 1 further comprising:
having a double hinge configuration.

7. A device according to claim 1 further comprising:
the hinges have a slight bend up angle.

8. A device according to claim 1 further comprising:
the hinges is offset from the edge between the roof and the rooftop panel.
